(19) United States
(12) Patent Application Publication
(10) Pub. No.: US 2010/0015434 A1
(43) Pub. Date: Jan. 21, 2010

(54) Assembling structure of a plated resin article

(75) Inventors: Yasuo Iwata, Aichi-ken (JP); Toshimichi Kawata, Aichi-ken (JP); Shigeyoshi Setsuda, Aichi-ken (JP); Yuji Sumi, Aichi-ken (JP); Takehiko Shiraki, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/458,387

(22) Filed: Jul. 9, 2009

(30) Foreign Application Priority Data
Jul. 17, 2008 (JP) 2008-186141

(51) Int. Cl. B32B 27/00

(52) U.S. Cl. 428/327

(57) ABSTRACT

The invention prevents an assembling structure of the plated resin article from generation of squeak noise with suppressing increase in costs. The assembling structure includes a first member including a first resin molded article at least a first surface of which is coated by a coating film; and a second member including a second resin molded article at least a second surface of which is plated by a plating film. The first member and the second member are assembled so as to frictionally contact at the coating of the first surface and the plating film of the second surface; and the coating film includes a particle made from a fluorine resin. The generation of squeak noise can be suppressed with maintaining the physical properties of the coating film, such as gloss and re-coating ability.

### CROSS-REFERENCE TO RELATED APPLICATIONS

This application claims priority from Japanese Patent Application No. 2008-186141 filed on Jul. 17, 2008, the entire subject matter of which is incorporated herein by reference.

### TECHNICAL FIELD

The present invention relates to an assembling structure of a first member obtained by coating a first resin and a second member obtained by plating a second resin. More specifically, it relates to an assembling structure with a slight clearance.

### BRIEF DESCRIPTION OF THE RELATED ART

For example, since a radiator grill for automobiles is viewed from the front, an excellent design is required. Therefore, such various radiator grills that coated same color as a car body, and that is chromium plated are known.

Moreover, recently, the number of separate-type radiator grills increases. The type of the radiator grill is assembled from a lattice-shaped inner member and a frame-shaped outer member covering the outer circumference of the inner member. The reason of this increase is that high costs and a large number of masking steps are caused when the whole of an integrated type radiator grill is plated and subsequently coated partially. When the separate-type is adopted, a profound design can be achieved and also the costs can be reduced by combining both members after one member is plated and another is coated.

Such a radiator grill having a separate structure is assembled by means of an engagement with engaging claws, combination with tapping screws, combination with resin clips, or the like. For example, in JP-A-2003-205803, it is described that, in an assembling structure where a grill mall (outer member) is assembled to a grill member (inner member), an engaging projection formed on the grill mall is engaged with an engaging rib formed on the grill member.

According to the assembling structure, the attachment can be achieved by a little force. Moreover, since an engaging rib capable of elastic deformation is formed on the grill member, even when the grill mall becomes hard through plating, an engaging force is not affected.

However, when the assembling structure described in the above publication is applied to a grill of an actual vehicle, squeak noise is generated due to a press force applied by pushing the grill with a hand or by leaning one's back against the grill. The squeak noise is generated since the grill member and the grill mall are relatively moved in frictional contact with each other. Such squeak noise is offensive to the user, and therefore, a premium accent is impaired.

Thus, countermeasures such as adherence of a felt onto a contact surface between the outer member and the inner member or application of a slipping agent or to reduce frictional resistance of a sliding contact surface have been taken but the man-hour and costs increase.

The invention is devised in consideration of the above circumstances and a problem to be solved is to prevent the generation of squeak noise while increase in costs is suppressed.

### SUMMARY

The assembling structure of a plated resin article according to the invention is an assembling structure of plated resin article including a first member including a first resin molded article at least a first surface of which is coated by a coating film, and a second member including a second resin molded article at least a second surface of which is plated by a plating film. The first member and the second member are assembled so as to frictionally contact at the coating of the first surface and the plating film of the second surface, and the coating film includes a particle made from a fluorine resin.

According to the studies of the present inventors, it was revealed that squeak noise was generated by the frictional contact of the plated surface with the coated surface. As a result of extensive studies, they found that the squeak noise was not generated when one surface of a pair of surfaces in frictional contact with each other was the surface of the substrate resin. The inventors applied for a patent as Japanese Patent Application No. 2007-161705.

According to the technology, since a felt or a slipping agent is not necessary, increase in costs can be suppressed. However, in this technology, it is necessary to expose the substrate surface partially and thus the degree of the freedom of designing is impaired and the man-hour for masking increases.

Thus, according to the assembling structure of the invention, the squeak noise can be suppressed by containing particles made of a fluorine resin in the coating film. Namely, since it is sufficient to perform coating with a paint obtained by mixing the particles made of a fluorine resin with the conventionally used paint, the felt, the slipping agent, and the like are not necessary and also masking is unnecessary, so that man-hour can be reduced to a large extent.

### BRIEF DESCRIPTION OF THE DRAWINGS

FIG. 1 is an exploded perspective view of the radiator grill according to one Example of the invention.

FIG. 2 is an exploded perspective view of a relevant part of the radiator grill according to one Example of the invention.

FIG. 3 is a cross-sectional view of a relevant part of the radiator grill according to one Example of the invention.

FIG. 4 is a cross-sectional view of a relevant part of the radiator grill according to one Example of the invention.

FIG. 5 is a cross-sectional view of a relevant part of the radiator grill according to one Example of the invention.

### DETAIL DESCRIPTION OF EXEMPLARY EMBODIMENTS OF THE PRESENT INVENTION

The assembling structure of a plated resin article of the invention includes a first member obtained by coating a first resin molded article and having a coating film and a second member obtained by plating a second resin molded article with a metal and having a plated film, the first member and the second member being assembled to each other.

With regard to the materials of the first resin molded article and the second resin molded article, various resins such as ABS, PA, and PP can be selected according to the intended purpose without particular limitation. The same resin may be used for the first resin molded article and the second resin molded article or different resins may be used.

The assemble of the first member and the second member can be achieved by forming a first engaging part on the first member, forming a second engaging part on the second member, and engaging the first engaging part and the second engaging part.

The engagement structure of the first engaging part and the second engaging part is preferably an engagement structure of a claw part and an engagement hole, for example. A general engagement structure of a claw part and an engagement hole can be engaged by merely pressing one of the first member and the second member toward the other. Thus, a small number of assembling steps is achieved.

In the engagement structure of the claw part and the engaging hole, it is common to utilize elastic deformation of the claw part. Namely, the claw part generally has a plate-shaped foot part and a latching claw formed on the end of the foot part. At the time when the claw is engaged with the engaging hole, a tapered face of the latching claw comes into contact with the other member and the foot part is elastically deformed. When the whole of the latching claw enters the engaging hole, the foot part gets back to the original shape by own elastic force, and the latching claw is engaged with the engaging hole.

Therefore, the engagement structure of the claw part and the engaging hole, in order to enable swing of the latching claw by the elastic deformation of the foot part, further in order to surely engage the latching claw with the engagement hole, slight clearance is necessary between the first member and the second member. The clearance remains after the engagement of the claw part with the engagement hole.

Therefore, for example, in the case of the assembling structure by the engagement of the claw part with the engagement hole, it is necessary to prevent breakage by regulating excessive movement induced by pressing at the time when one of the first member and the second member is pressed toward the other.

Thus, it is desirable that a regulating face is formed on at least one of the first member and the second member and a regulating rib regulating the movement in frictional contact with the regulating face is formed on at least another of the first member and the second member. At the time when one of the first member and the second member is pressed toward the other, the regulating rib comes into contact with the regulating face and thus further movement is regulated, so that troubles such as breakage can be prevented.

The first member has a first surface having the coating film, the second member has a second surface having the plated film, and the coating film of the first surface and the plated film of the second surface is in frictional contact with each other. The first surface and the second surface can be, for example, the above regulating face and regulating rib surface. When the regulating face is the first surface, the surface of the regulating rib opposite to the regulating face is the second surface. Alternatively, when the regulating face is the second surface, the surface of the regulating rib opposite to the regulating face is the first surface.

The first member necessarily has a coating film at least on the first surface. The portions other than the first surface may not have a coating film but it is desirable to have a coating film on a designed surface or a surface which is not the designed surface, in order to do without masking. The type of the paint for forming the coating film is not particularly limited and the coating film can be formed by coating with any of known various paints. The thickness of the coating film may be common one such as 10 to 50 μm and the coating film can be a coating film having any of various color tones, such as a clear coating film, a solid color coating film, or a metallic coating film. As the paint capable of being applied to ABS or the like, for example, there are two-component curable acrylic urethane resin paints and the like.

The most characteristic feature of the invention lies on the fact that at least the coating film formed on the first surface contains particles made of a fluorine resin. Thereby, squeak noise at the time when the coating film comes into contact with the plated film of the second surface can be suppressed to a large extent.

The content of the particles made of a fluorine resin in the coating film is preferably in an amount equal to or less than 11% by mass. When the amount is more than 11% by mass, the effect of suppressing the squeak noise is saturated as well as gloss and transparency of the coating film sometimes decrease and physical properties of the coating film are adversely affected in some cases. Since the effect depends on the type of the paint, particle size and molecular weight of the particles made of a fluorine resin, or combinations thereof, the lower limit cannot be defined but it is desirable to contain the particles in an amount of 2% by mass or more.

Examples of the fluorine resin include polytetrafluoroethylene (PTFE), tetrafluoroethylene-perfluoroalkyl vinyl ether copolymer (PFA), tetrafluoroethylene-hexafluoropropylene copolymer (FEP), tetrafluoroethylene-ethylene copolymer (ETFE), polyvinylidene fluoride (PVDF), polychlorotrifluoroethylene (PCTFE), chlorotrifluoroethylene-ethylene copolymer (ECTFE), and the like. Of these, when particles made of polytetrafluororethylene are used, the effect is exhibited even in a small amount thereof. In the case where polytetrafluoroethylene is used, it is preferable to use the one having a number-average molecular weight of 1,000 to 500,000.

The shape of the particles made of a fluorine resin may be spherical one, scurf one, amorphous one, or the like and is not particularly limited. Moreover, the particle size is not particularly limited so far as it is not more than the film thickness of the coating film but is preferably in the range of 1 to 10 μm and particularly desirably in the range of 2 to 5 μm. When the particle size is smaller than the range, handling workability decreases and when the particle size is larger than the range, the surface roughness of the coating film increases.

For the formation of the coating film on the first resin, the particles made of a fluorine resin are first mixed into the paint. The amount of the particles to be mixed is determined in reference to non-volatile matter in the paint. In the case where the acrylic urethane resin paint is used, the particles are mixed into an acrylic polyol resin solution but the amount is determined based on the total non-volatile matter in the polyol resin solution and a polyisocyanate resin solution.

The coating method is not particularly limited and various coating methods such as spray coating and electrostatic coating can be used. Then, the coating material is subjected to a drying step and the first member is formed by drying the material at a predetermined temperature for a predetermined time. The coating can be applied on the whole surface of the designed surface and, if necessary, also on the rear surface thereof and masking can be omitted, so that there is no increase in man-hour as compared with the conventional method.

Moreover, the second member is obtained by plating the second resin molded article with a metal and has a plated film. The type of plating is desirably metallic chromium plating but is not limited thereto. Similarly to the conventional manner, the chromium-plated film or the like can be formed by forming a conductive film of copper, nickel or the like through electroless plating and subsequently performing electric plating. The thickness of the plated film may be also common one.

In the assembling structure of a plated resin article of the invention, when the first member or the second member is pressed, the first surface and the second surface come into frictionally contact with each other. However, since the coating film contains the particles made of a fluorine resin, the generation of squeak noise is prevented.

The following will specifically describe the invention with reference to Embodiments and Comparative Examples. In the present embodiments, the invention is applied to an assembling structure of a grill member and a grill mall of a radiator grill of an automobile.

### Embodiment 1

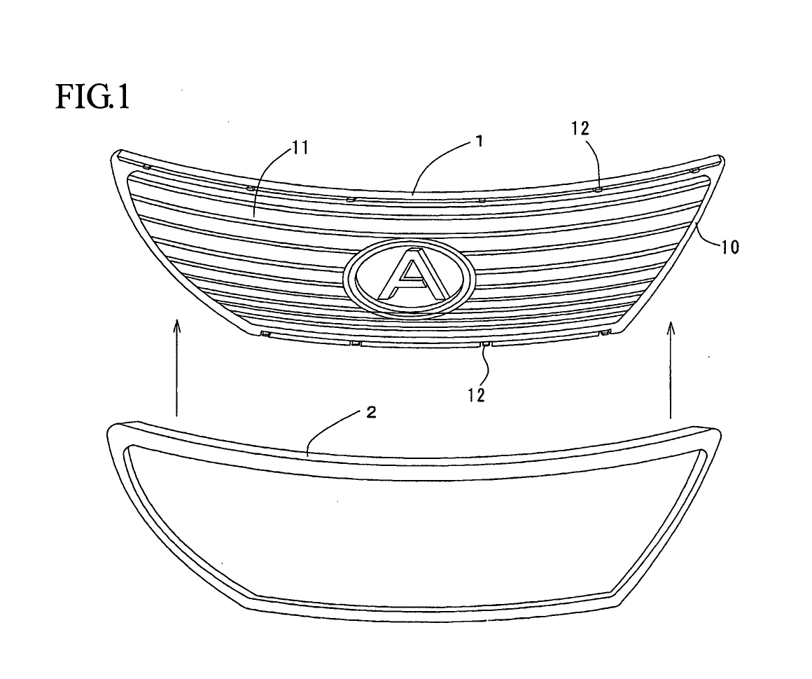

FIG. 1 shows the radiator grill of the present embodiment. The radiator grill has a grill member 1 made of ABS resin and a grill mall 2 made of ABS resin which is fixed to an outer circumference of the grill member 1.

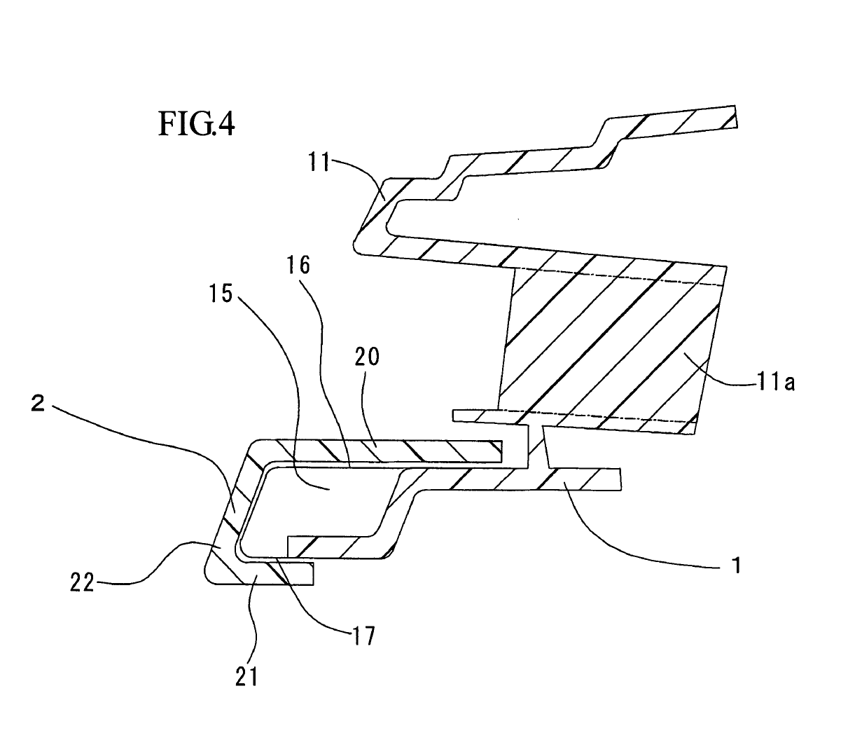

The grill member 1 has an almost quadrangular frame body 10 defining the outer circumference and a plurality of plates 11 which partition the inside of the frame body 10 in a vertical direction into a plurality of portions and are parallel to one another. Adjacent plates 11 are partially connected to each other with a connecting plate 11a (see FIG. 4). From the upper part and lower part of the frame body 10, a plurality of claw parts 12 projecting forward are formed. Each of the claw parts 12 has a plate-shaped foot part 13 and a latching claw 14 which is formed on the end of the foot part 13 and has a cross-section of a triangular shape and the foot part 13 is elastically deformable so as to be bent in its thickness direction. Moreover, on the frame body 10, a plurality of regulating ribs 15 projecting forward are formed at positions between the claw parts 12. Furthermore, on the frame body 10, a plurality of brackets for attachment to an automobile body, which are not shown in the figure, are formed.

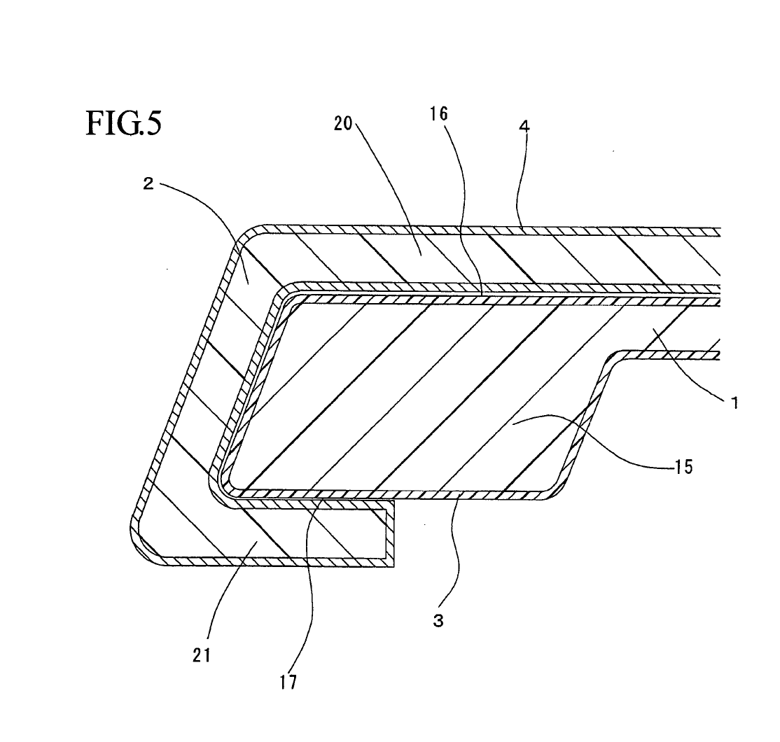

The grill member 1 has a metallic coating film 3 formed by coating the whole front and rear surfaces with an acrylic urethane-based metallic paint (FIG. 5). The metallic coating film 3 contains a polytetrafluoroethylene powder (hereinafter referred to as PTFE powder) in an amount of 3% by mass and its average film thickness is 20 μm.

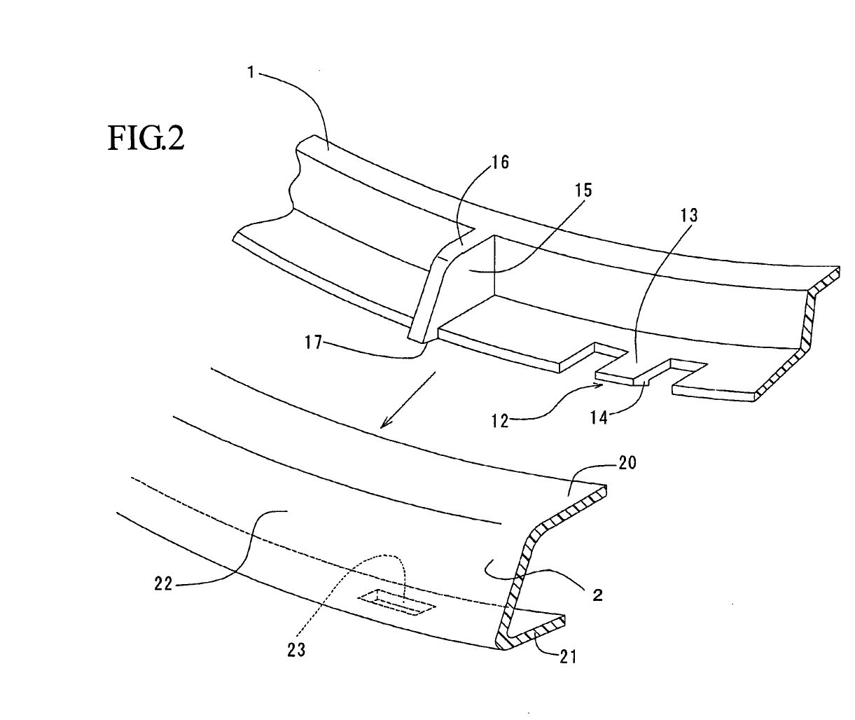

One grill mall 2 is formed into a cross-section of almost horseshoe shape composed of an upper wall 20, a lower wall 21, and a central wall 22 connecting the upper wall 20 and the lower wall 21 and the surface at the convex side forms the designed surface. The grill mall 2 is formed as a frame shape corresponding to the outer circumference of the grill member 1, a plurality of engaging holes 23 are formed on the upper wall 20 at the upper side of the frame, and a plurality of engaging holes 23 are formed on the lower wall 21 at the lower side of the frame (FIG. 2).

On the grill mall 2, a Ni film is formed by electroless plating after etching treatment and a chromium-plated film 4 (FIG. 5) formed by subsequent electric plating is formed on the whole front and rear surfaces.

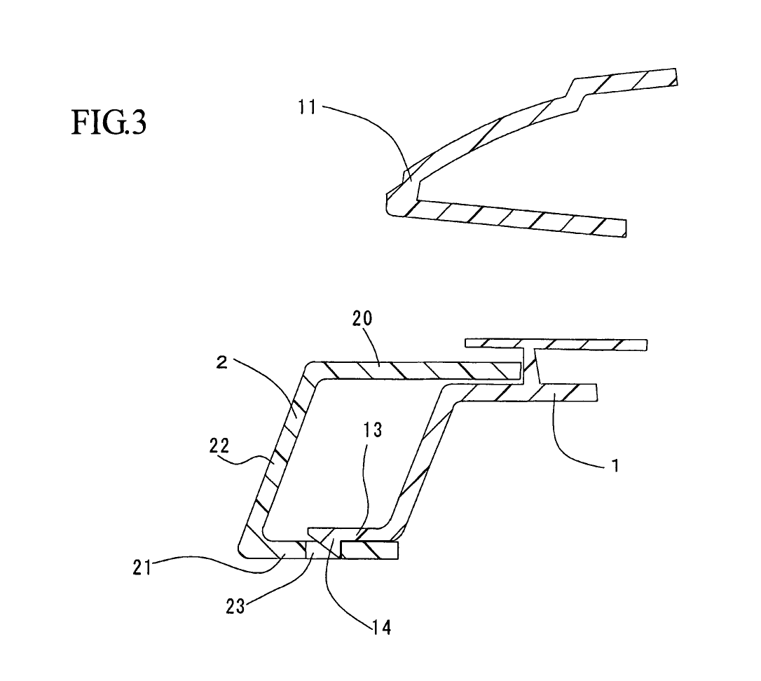

For assembling the grill mall 2 to the grill member 1, the grill mall 2 is disposed from the surface side of the grill member 1 so that the grill mall 2 is positioned at the outer circumference of the grill member 1, and they are pressed toward such a direction that they come close to each other. Whereat, the latching claws 14 of a plurality of the claw parts 12 provided above and below as shown in FIG. 1 come into contact with the upper wall 20 and the lower wall 21, respectively, and are pressed to elastically deform the foot parts 13 toward the inner circumference side. When the whole of the engaging claws 14 reach the positions of the engaging holes 23, the engaging claws 14 are engaged with the engaging holes 23 by an elastic force. Thereby, as shown in FIG. 3, the grill mall 2 is attached to the grill member 1.

As shown in FIG. 4, the upper surface 16 and the lower surface 17 of the regulating rib 15 are opposed to the inner circumference surfaces of the upper wall 20 and the lower wall 21 of the grill mall 2, respectively. When the grill mall 2 is pressed from the front surface side, the upper surface 16 and the lower surface 17 of the regulating rib 15 come into frictional contact with the inner circumference surfaces of the upper wall 20 and the lower wall 21.

However, in the radiator grill of the present embodiment, the chromium-plated film 4 formed on the inner circumference surfaces of the upper wall 20 and the lower wall 21 is in frictional contact with the metallic coating film 3 formed on the regulating rib 15. The metallic coating film 3 contains the PTFE powder. Therefore, the generation of squeak noise is prevented and there is not a problem of impairing a premium accent.

The following will describe a method for forming the metallic coating film 3. It is a substitute for detailed description of the composition of the metallic coating film 3.

A two-component curable acrylic urethane resin paint (“OPZ-11GY08 color” manufactured by Origin Electric Co., Ltd.) was prepared. The paint is composed of a liquid A containing an acrylic polyurethane as a main component, an aluminum pigment, and a colored pigment and a liquid B containing a polyisocyanate as a main component. A PTFE powder A (number-average molecular weight: 1,000 to 500,000; particle size: 2 μm) was mixed into the liquid A under stirring with a mixer. The amount of the PTFE powder A mixed is 1% by weight, which corresponds to 3% by weight as PWC, in a mixture at coating where the liquid A and the liquid B are mixed in a predetermined ratio.

The liquid A containing the PTFE powder A and the liquid B were mixed in a predetermined ratio, the mixture was diluted to a coating viscosity with thinner, and the whole surface of the grill member 1 was coated by air spray. After the coating, the grill member was allowed to stand for 10 minutes and then dried at 70° C. for 30 minutes to form a metallic coating film 3. The average film thickness after drying is 30 μm.

Table 1 shows a detailed composition of the paint containing the mixture of liquid A and the liquid B. Moreover, when the cross-section of the metallic coating film 3 was analyzed by EPMA, it was observed that fluorine atoms were homogeneously distributed all over the metallic coating film 3.

The obtained grill member 1 and the grill mall 2 having the chromium-plated film 4 were combined as shown in FIG. 3 and FIG. 4 to construct the radiator grill of the present Embodiment.

### Embodiment 2

The Embodiment 2 is the same as Embodiment 1 except that the amount of the PTFE powder A is changed to 2% by weight in a mixture at coating where the liquid A and the liquid B are mixed in a predetermined ratio and the content (=PWC) of the PTFE powder A in the metallic coating film 3 is changed to 6% by weight.

### COMPARATIVE EXAMPLE 1

The Comparative Example 1 is the same as Embodiment 1 except that the metallic coating film 3 does not contain the PTFE powder A.

### COMPARATIVE EXAMPLE 2

The Comparative Example 2 is the same as Embodiment 1 except that the amount of the PTFE powder A is changed to 4% by weight in a mixture at coating where the liquid A and the liquid B are mixed in a predetermined ratio and the content (=PWC) of the PTFE powder A in the metallic coating film 3 is changed to 11.4% by weight.

### TEST EXAMPLE

With regard to the radiator grills of respective Embodiments and Comparative Examples, the evaluation of the squeak noise is performed in the following manner. The grill mall 2 was pressed with hand fingers toward the grill member 1 while the grill member 1 was under fixed condition. The generation of squeak noise was evaluated in a sensory manner. The results are shown in Table 1. In Comparative Example 1, squeak noise offensive to the ear was generated, so that the case was evaluated as X. The case where squeak noise was hardly generated was evaluated as o and the case where noise was hardly offensive to the ear even when squeak noise was generated was evaluated as Δ to ◯.

Moreover, the gloss of the metallic coating film 3 was visually evaluated and also the gloss of the metallic coating film 3 was measured by means of a gloss meter. The results are shown in Table 1.

Furthermore, an adherability test was also performed in the case where the grill member 1 was re-coated with a paint. The drying time for a first layer of the metallic coating film 3 was 60 minutes at 70° C. and, after it was allowed to stand for 240 hours, the surface was coated with the same metallic paint as the one used for the first layer and then dried at 70° C. for 30 minutes. After standing to cool to room temperature, the surface was subjected to a cross cut test and then immersed in a warm water at 40° C. for 240 hours and the case which had no peeling of the coating film was generated was evaluated as “◯”. The results are shown in Table 1.

From Table 1, it is revealed that squeak noise is suppressed in the radiator grills of Embodiments 1 and 2 as compared with Comparative Example 1 and thus it is obvious that this suppression is an effect of containing the PTFE powder A in the metallic coating film 3. Moreover, when the content of the PTFE powder A increases, squeak noise is prevented but the gloss decreases as shown in Comparative Example 2. Therefore, the content of the PTFE powder A in the metallic coating film 3 is desirably equal to or less than 11% by mass. In this connection, even when the metallic coating film 3 contains the PTFE powder A, it is revealed that there is no influence on the re-coating ability.

### Embodiment 3

In the Embodiment 3, “OPZ-HG-11GY24 color” (manufactured by Origin Electric Co., Ltd.) was used as a two-component curable acrylic urethane resin paint for use in the coating of the grill member 1 and the coating was performed so that the amount of the PTFE powder A in the metallic coating film 3 became 5.7% by weight. Table 2 shows the composition of the paint. Then, tests were performed in the same manner as in the above Test Example. The results are shown in Table 2.

### Embodiment 4

The operations are the same as in Embodiment 3 except that a PTFE powder B (number-average molecular weight: 1,000 to 500,000; particle size: 5 to 7 μm) was used as a polytetrafluoroethylene powder and the coating was performed so that the amount of the PTFE powder B in the metallic coating film 3 became 5.7% by weight. Table 2 shows the composition of the paint. Then, tests were performed in the same manner as in the above Test Example. The results are shown in Table 2.

### Embodiment 5

The operations are the same as in Embodiment 3 except that the coating was performed so that the amount of the PTFE powder B in the metallic coating film 3 became 10.9% by weight. Table 2 shows the composition of the paint. Then, tests

TABLE 1

| | | Comparative | | | | | | Comparative | |
|---|---|---|---|---|---|---|---|---|---|
| | | Example 1 | | Example 1 | | Example 2 | | Example 2 | |
| | Composition | wt % | PWC | wt % | PWC | wt % | PWC | wt % | PWC |
| Solid matter | Acrylic polyol | 22.3 | — | 22.1 | — | 21.9 | — | 21.4 | — |
| | Polyisocyanate | 5.4 | — | 5.3 | — | 5.3 | — | 5.2 | — |
| | Aluminum | 3.6 | 11.1 | 3.6 | 10.9 | 3.5 | 10.4 | 3.5 | 10.0 |
| | powder | | | | | | | | |
| | Black pigment | 0.3 | 0.9 | 0.3 | 0.9 | 0.3 | 0.9 | 0.3 | 0.9 |
| | Blue pigment | 0.1 | 0.4 | 0.1 | 0.3 | 0.1 | 0.3 | 0.1 | 0.3 |
| | Red pigment | 0.1 | 0.2 | 0.1 | 0.3 | 0.1 | 0.3 | 0.1 | 0.3 |
| | Extender pigment | 0.4 | 1.2 | 0.4 | 1.2 | 0.4 | 1.2 | 0.4 | 1.1 |
| | PTFE powder A | — | — | 1.0 | 3.0 | 2.0 | 6.0 | 4.0 | 11.4 |

| | | | | | | | | |
|---|---|---|---|---|---|---|---|---|
| Solvent | 67.5 | — | 66.8 | — | 66.1 | — | 64.8 | — |
| Additive | 0.3 | — | 0.3 | — | 0.3 | — | 0.3 | — |

| | | | | |
|---|---|---|---|---|
| Gloss (visual) | ∘ | ∘ | Δ-∘ | x |
| Gloss (Measured value) | 55 | 50 | 40 | 23 |
| Re-coating adherability | ∘ | ∘ | ∘ | ∘ |
| Squeak noise | x | ∘ | ∘ | ∘ |

were performed in the same manner as in the above Test Example. The results are shown in Table 2.

### COMPARATIVE EXAMPLE 3

The operations are the same as in Embodiment 3 except that the metallic coating film 3 does not contain the PTFE powder A and the PTFE powder B.

From Table 2, it is obvious that squeak noise is suppressed by containing the PTFE powder A or the PTFE powder B in the metallic coating film 3. When the PTFE powder A and the PTFE powder B are compared, there is no difference between both powders in view of the effect of suppressing squeak noise but, with regard to the gloss, the degree of decrease is smaller in the case of the PTFE powder B having a larger particle size. However, since the gloss decreases as the content increases even in the case of the PTFE powder B, it is considered that the content of the PTFE powder B in the metallic coating film 3 is desirably equal to or less than 11% by mass.

### Embodiment 6

In the Embodiment 6, “PZ-3-11GY24 color” (manufactured by Origin Electric Co., Ltd.) was used as a two-component curable acrylic urethane resin paint for use in the coating of the grill member 1 and the coating was performed so that the amount of the PTFE powder A in the metallic coating film 3 became 3.2% by weight. Table 3 shows the composition of the paint. Then, tests were performed in the same manner as in the above Test Example. The results are shown in Table 3.

TABLE 2

| | | Comparative | | | | | | | |
|---|---|---|---|---|---|---|---|---|---|
| | | Example 3 | | Example 4 | | Example 3 | | Example 5 | |
| | Composition | wt % | PWC | wt % | PWC | wt % | PWC | wt % | PWC |
| Solid matter | Acrylic polyol | 25.2 | — | 24.7 | — | 24.7 | — | 24.2 | — |
| | Polyisocyanate | 5.4 | — | 5.3 | — | 5.3 | — | 5.2 | — |
| | Aluminum | 1.8 | 5.1 | 1.8 | 5.1 | 1.8 | 5.1 | 1.7 | 4.6 |
| | powder | | | | | | | | |
| | Black pigment | 0.1 | 0.3 | 0.1 | 0.3 | 0.1 | 0.3 | 0.1 | 0.3 |
| | Blue pigment | 0.1 | 0.2 | 0.1 | 0.3 | 0.1 | 0.3 | 0.1 | 0.3 |
| | Red pigment | 0.1 | 0.2 | 0.1 | 0.3 | 0.1 | 0.3 | 0.1 | 0.3 |
| | Extender pigment | 1.2 | 3.4 | 1.2 | 3.4 | 1.2 | 3.4 | 1.2 | 3.3 |
| | PTFE powder B | — | — | 2.0 | 5.7 | — | — | 4.0 | 10.9 |
| | PTFE powder A | — | — | — | — | 2.0 | 5.7 | — | — |

| | | | | | | | | |
|---|---|---|---|---|---|---|---|---|
| Solvent | 64.7 | — | 63.4 | — | 63.4 | — | 62.1 | — |
| Additive | 1.4 | — | 1.4 | — | 1.4 | — | 1.3 | — |

| | | | | |
|---|---|---|---|---|
| Gloss (visual) | ∘ | ∘ | Δ | Δ |
| Gloss (Measured value) | 70 | 68 | 57 | 62 |
| Re-coating adherability | ∘ | ∘ | ∘ | ∘ |
| Squeak noise | x | Δ to ∘ | Δ to ∘ | ∘ |

### Embodiment 7

The Embodiment 7 is the same as in Embodiment 6 except that the coating was performed so that the amount of the PTFE powder B in the metallic coating film 3 became 6.2% by weight. Table 3 shows the composition of the paint. Then, tests were performed in the same manner as in the above Test Example. The results are shown in Table 3.

### COMPARATIVE EXAMPLE 4

The Comparative Example 4 is the same as in Embodiment 6 except that the metallic coating film 3 does not contain the PTFE powder A.

It is obvious that squeak noise can be suppressed with maintaining the physical properties of the coating film as in the other Examples by containing the PTFE powder A in the metallic coating film 3 even when the type of the paint is changed.

### INDUSTRIAL APPLICABILITY

The assembling structure of a plated resin article of the invention is not limited to a radiator grill and can be utilized for decorative members having both of a metal-plated film and a coating film, such as a side mall and an ornament.

TABLE 3

| | | Comparative | | | | | |
|---|---|---|---|---|---|---|---|
| | | Example 4 | | Example 6 | | Example 7 | |
| | Composition | wt % | PWC | wt % | PWC | wt % | PWC |
| Solid matter | Acrylic polyol | 34.1 | — | 33.6 | — | 33.1 | — |
| | Polyisocyanate | 8.2 | — | 8.1 | — | 8.0 | — |
| | Aluminum | 2.0 | 4.2 | 2.0 | 4.2 | 1.9 | 3.9 |
| | powder | | | | | | |
| | Black pigment | 0.1 | 0.2 | 0.1 | 0.2 | 0.1 | 0.2 |
| | Blue pigment | 0.1 | 0.2 | 0.1 | 0.2 | 0.1 | 0.2 |
| | Red pigment | 0.1 | 0.2 | 0.1 | 0.2 | 0.1 | 0.2 |
| | Extender | 2.0 | 4.2 | 2.0 | 4.2 | 2.0 | 4.1 |
| | pigment | | | | | | |
| | PTFE powder | — | — | 1.5 | 3.2 | 3.0 | 6.2 |
| | B | | | | | | |

| | | | | | | |
|---|---|---|---|---|---|---|
| Solvent | 51.9 | — | 51.1 | — | 50.3 | — |
| Additive | 1.5 | — | 1.5 | — | 1.5 | — |

| | | | |
|---|---|---|---|
| Gloss (visual) | ∘ | ∘ | Δ to ∘ |
| Gloss (Measured value) | 86 | 82 | 73 |
| Re-coating adherability | ∘ | ∘ | ∘ |
| Squeak noise | x | Δ to ∘ | ∘ |

1. An assembling structure of a plated resin article comprising:
a first member including a first resin molded article at least a first surface of which is coated by a coating film; and
a second member including a second resin molded article at least a second surface of which is plated by a plating film; wherein
the first member and the second member are assembled so as to frictionally contact at the coating of the first surface and the plating film of the second surface; and
the coating film includes a particle made from a fluorine resin.

2. The assembling structure of plated resin article according to claim 1, wherein the coating film is an acrylic urethane coating and the plating film is a chrome plating film.

3. The assembling structure of plated resin article according to claim 1, wherein the particle is made of poly-tetra-fluoroethylene, and contained in the coating film in an amount equal to or less than 11% by mass.

4. The assembling structure of plated resin article according to claim 2, wherein the particle is made of poly-tetra-fluoroethylene, and contained in the coating film in an amount equal to or less than 11% by mass.
